(19) United States
(12) Patent Application Publication
(10) Pub. No.: US 2010/0303229 A1
(43) Pub. Date: Dec. 2, 2010

(54) MODIFIED COUNTER MODE ENCRYPTION

(76) Inventor: Gregory UNRUH, San Clemente, CA (US)

Correspondence Address: James P. Broder;Roeder & Broder LLP, 9915 Mira Mesa Blvd. Suite 300, San Diego, CA, 92131, US

(21) Appl. No.: 12/472,945

(22) Filed: May 27, 2009

(51) Int. Cl. H04L 9/28

(52) U.S. Cl. 380/28

(57) ABSTRACT

A modified Counter Mode encryption technique encrypts data by receiving a seed value, generating a first value from an operation of the seed value and the plaintext; and encrypting the first value using a block encryption cipher to produce ciphertext. The operation may be an exclusive-or operation. The seed value may be a counter value based upon a position of the block of plaintext in a record of plaintext, where the length of the counter value is based upon the length of the block. The counter value may be generated by adding an initialization vector to a product of an index value and a multiplier value, where the multiplier value comprises a randomly-generated value, the index value is based upon the position of the block of plaintext in the record of plaintext, and the length of the initialization vector and the length of the multiplier value are based upon the length of the block.

### BACKGROUND

1. Field

The present application relates generally to data security and more specifically to secure encryption of data.

2. Related Art

Data encryption methods are known in the art. Data encryption is widespread use for protecting confidential information from unauthorized access. For example, a bank may encrypt customer account information before storing the information on a disk, a hospital may encrypt patent medical records, and an online merchant may encrypt customer orders and payment information. The encrypted information may be safely stored or transmitted over a computer network, as any person who obtains encrypted information will not be able to recover the original information without an encryption key, which is a secret value such as a password that is provided when the data is encrypted. The same secret key ordinarily must be provided to recover, i.e., decrypt the data.

In block cipher encryption, a data record to be encrypted is divided into blocks, and an encryption operation is performed on each block to transform the block to a corresponding block of encrypted data. The data to be encrypted is referred to as plaintext, and the encrypted data is referred to as ciphertext. The ciphertext blocks are concatenated to form an encrypted data record. The plaintext data can be extracted using a key, which is a data value provided to the encryption operation. Without knowledge of the key value, the plaintext cannot ordinarily be deduced from the ciphertext unless an attacker is able to exploit some weakness of the encryption method or apply an automated brute-force attack such as trying every possible key value, which may take months or years for key lengths that are of sufficient length to be considered secure relative to contemporary computational resources.

An “attacker” may attempt to obtain the original plaintext without knowing the key, e.g., by guessing the key or exploiting a weakness in the encryption method. An example of such a weakness is “leakage” of some portion of the original information through the encryption method to the encrypted information. For example, suppose that an encryption method encrypts the plaintext sequence [1, 2, 3, 4, 5] to produce the ciphertext [34, 4, 65, 16, 211]. The second and fourth values have leaked through to the ciphertext, because the second and fourth values of the ciphertext, 4 and 16, are related to corresponding values of the plaintext (i.e., the squares of the second and fourth values of the plaintext). If this leakage repeats in some deterministic way every time the encryption method is applied, then an attacker may be able to use the leakage to deduce properties about the plain text. For example, if the second and fourth values of the ciphertext are always the squares of the second and fourth plaintext values, then an attacker can decrypt the second and fourth values by taking their square root. The strength of an encryption method therefore depends on the difficulty of recovering the plaintext from the ciphertext.

Block ciphers are susceptible to leakage of information from the plaintext to the ciphertext. Leakage occurs in block ciphers primarily because encrypting two identical blocks of ciphertext may produce the same ciphertext. Leakage may occur when, for example, two different database records have a field with the same value, and are encrypted using a block cipher. An attacker who has knowledge about the structure of the plaintext data may be able to determine from the ciphertext that the fields in two different encrypted records or messages have the same value, and may exploit the leakage by, for example, deducing the effect of that value on the operation of the system. The attacker may be able to deduce, for example, that a certain type of confidential event has occurred in response to a request message. The attacker may then act on the knowledge that the otherwise confidential event has occurred.

As a preliminary note, the term XORed is used herein to denote application of the XOR (exclusive-or) operation to two values to produce a result that is the exclusive-or of the two values. The exclusive-or of two 1-bit binary values is 0 if the values are equal, or 1 if the values are not equal. Therefore, the exclusive-or (XOR) operation is a comparator that produces the value 0 if its operands are equal, and 1 if its operands are not equal. Other logical operations may be used in place of the XOR operation. For example, the exclusive-nor (XNOR) operation is essentially an XOR operation followed by a logical NOT (negation) operation. The XNOR of two binary values is 1 if the values are equal, or 0 if the values are not equal. The XNOR operation is therefore also a comparator. The terms “compare” and “comparing” as used herein refer to an operation that compares input values and produces a result that indicates whether the input values are equal. Two data values of any specified bit length may be compared by comparing the data values bit-by-bit, i.e., comparing each corresponding pair of bits in the two data values, as known to those skilled in the art

Block cipher encryption has been extended with additional “modes” that reduce the amount of information leakage. The Cipher Block Chaining (CBC) block cipher mode introduces an initialization vector (IV) that is XORed with the plaintext before the plaintext is passed to the block cipher. Then the output of the first block cipher is XORed with the second block of plaintext before being passed to the block cipher. This technique obscures regions that have repeated blocks of plaintext, because the XOR operation varies the plaintext input to each block cipher. The plaintext is obscured in a way that can be reversed if the IV is known, and the IV is available to the decryption operation. The Counter block cipher mode (CTR) concatenates the IV with a counter that is unique for each block in a data record. If the IV is unique for each data record, then the combined IV and counter will be unique for each encryption operation. Since the input to each block cipher can be computed independently of the other blocks, CTR mode can used parallelization techniques to achieve higher performance than CBC mode, in which the input to each block cipher depends on the output of the previous cipher.

Message authentication methods are known in the art and provide authentication codes that can be used to verify that a data record has not been changed since the authentication code was generated. Message authentication methods such as MD5 (Message Digest 5) or SHA-1 (Secure Hash Algorithm-1) generates a numeric message authentication code (MAC) based on a data record, and generate the same MAC each time the same method is applied to the same data record. If the data record is modified, however, the message authentication method generates a different MAC. Message authentication can be used in combination with data encryption, by, for example, encrypting the MAC, to provide assurance that a data record has not been modified since the MAC was computed.

There is a need for authenticated encryption at high data rates, e.g., 10 gigabits per second or higher. A block cipher encryption method known as Galois/Counter Mode (GCM) is a combination of counter mode encryption and the Galois mode of authentication. Galois authentication uses Galois field multiplication that can be implemented in parallel, and GCM authenticated encryption can consequently be implemented in hardware using pipelining and parallelization to achieve high speed and low-latency. GCM may be implemented in software, using table-driven techniques to yield excellent performance.

FIG. 1 illustrates a prior art Galois Counter Mode encryption operation. FIG. 1 shows encryption of three blocks of plaintext labeled Plaintext 1, Plaintext 2, and Plaintext N, to produce three corresponding blocks of ciphertext labeled Ciphertext 1, Ciphertext 2, and Ciphertext N, respectively. FIG. 1 also shows an authentication tag (labeled Auth Tag), which is generated by applying a hash function to each block of ciphertext. The hash function is shown as mult_{H} in FIG. 1, where mult_{H} refers to Galois field multiplication by a factor H, as described below. A single GCM encryption operation encrypts a single block of data. Encryption of data records larger than one block is achieved by dividing the data record into blocks and performing the encryption algorithm on each block, as introduced above. When an encryption operation is performed on a block, the GCM operation accepts the following values as input: a secret key, an initialization vector, a plaintext, and optional additional authenticated data, which is data to be authenticated but not encrypted.

The input to a GCM encryption operation includes the plaintext to be encrypted, the encryption key, and an initialization vector (IV), which in GCM encryption must be unique for each encryption operation with the same key (i.e., unique for each invocation of the block encryption operation), and optional additional authenticated data, which is data to be authenticated but not encrypted. The IV is ordinarily a random value with a predetermined length, e.g., 96 bits. The initialization vector is encrypted along with the plaintext, so that the IV is available to the decryption operation. The output of the GCM encryption operation includes a ciphertext of the same length as the plaintext, and, if the optional authenticated data was supplied, an authentication code value for the optional authenticated data. The authentication code may be used when the ciphertext is decrypted to verify that the optional authenticated data has not changed.

As introduced above, GCM operates by performing encryption operations on blocks of plaintext to produce blocks of ciphertext, and concatenating the ciphertext. The block size is fixed, e.g., 128 bits, 256 bits, and the like, and an encryption operation is performed on each block of plaintext. For example, to encrypt a plaintext data record having 1024 bits of data (1 byte), using a block size of 128 bits, 8 encryption operations would be performed, one for each 128 bits of data. If the plaintext data record's size is not a multiple of the block size, then the last block may be an incomplete block.

GCM encrypts data using a block cipher, e.g., the Advanced Encryption Standard cipher (AES), Triple-DES, IDEA, RC6 or the like, to encrypt the blocks of plaintext. The block cipher is used to encrypt a counter value, referred to herein as “Counter i” , using an encryption key. The same key is used for each block of the plaintext data record, but a different counter value is used as the input to each encryption operation for the plaintext data record. The exclusive-or of each plaintext block with the corresponding encrypted counter is then computed to produce ciphertext.

The optional authentication feature is provided by computing the exclusive-or of the ciphertext and a hash value produced by Galois field multiplication by a hash factor H (the multiplication by H is shown as blocks labeled mult_{H} in FIG. 1). Galois field multiplication is multiplication over the field GF(2¹²⁸). The multiplication operation is defined in the GCM specification document “The Galois/Counter Mode of Operation (GCM)” by David A. McGrew and John Viega. Galois field addition is equivalent to the bitwise exclusive-or (XOR) operation. To generate the authentication code, an initial hash value is generated by multiplication of the additional authenticated data by the hash factor H. For each encryption block, the exclusive-or of the hash value of the previous block (or the initial hash value, for the first block) and the block's ciphertext is multiplied by the hash factor H to produce a hash value for that block. The hash value generated by the final (i.e., last) block is XORed with the length of the initial authenticated data concatenated with the length of the ciphertext, and that result is multiplied by the hash factor H, and then XORed with the encrypted value of an initial counter value, referred to herein as “Counter 0”, which is the predecessor value (according to a counter increment operation) of the Counter 1 value used for the first block. The result of those operations is the authentication tag, which is an unencrypted authentication code that can be used to verify the authenticity of the encrypted data without performing a decryption operation.

To decrypt the ciphertext, the order of the hash step and the encrypt step are reversed, so that the result of encrypting each counter value is XORed with the ciphertext of each corresponding block to produce the plaintext for that block.

Counter mode encryption exhibits leakage of information from the input data to the output data. If the same initialization vector is used twice with the same key, then the output has the property that the exclusive-or of two blocks of output generated using the same initialization vector is equal to the exclusive-or of the corresponding two blocks of input. That knowledge could be useful to an attacker who knows one of the inputs because, for example, knowing the input and corresponding output may assist the attacker in deducing the encryption key. Some types of inputs, e.g., financial records, may have portions of data that remain unchanged in multiple data records. An attacker may recover multiple-record sequences of data. It would be desirable therefore, to have an encryption technique with the benefits of GCM, but without the requirement that the initialization vectors be unique for each key.

### SUMMARY

A reduced leakage counter mode encryption technique computes the exclusive-or of a counter value with a plaintext block, and encrypts the result of the exclusive-or using a block cipher such as AES. The reduced leakage technique does not produce information leakage when invoked two or more times with the same key and initialization vector. An attacker can determine whether two encrypted blocks are identical, but cannot discover the differences in plaintext if the two encrypted blocks are different.

In a first aspect, the invention features a reduced leakage encryption technique for encrypting data. The technique compares the counter value, Counter i, with the plaintext block corresponding to the counter (e.g., operates on the counter value and the plaintext block), and encrypts the result of the comparison using the block encryption cipher, e.g., AES or the like. The comparison may be performed using an exclusive-or operation, an exclusive nor operation, computer program instructions such as an if statement, a comparison instruction or the like. In the description herein, the term “exclusive-or” will be used for explanatory purposes, but other forms of comparison may be used in place of the exclusive-or operation, such as exclusive-nor, comparison instructions, and the like. The technique continues by exclusive-or-ing (abbreviated herein as XORing) the block of ciphertext with a multiplication factor generated for the previous block to produce a multiplication factor for the current block, and passing the multiplication factor for the current block to the next block. The technique continues by encrypting the next block of the data record using the same technique if the length of the remaining unencrypted plaintext in the data record is greater than zero. That is, for the next block, the counter value Counter i (e.g., for i=2), computing the exclusive-or of the next block of plaintext to produce the next block of ciphertext if there is more plaintext to encrypt, and XORing the multiplication factor from the block preceding the next block with the ciphertext of the next block to generate the multiplication factor of the next block., until the last block of plaintext has been encrypted, and generating the authentication tag, as described below.

For the last block, an authentication tag is generated based upon the exclusive-or of the last block's multiplication factor. The multiplication factor generated by the last block encryption operation is XORed with a value based on the lengths of the additional authenticated data and the length of the ciphertext, encrypted using the block cipher, and the result is XORed with an encrypted value generated by encrypting the “Counter 0” value described above to produce the authentication tag. The authentication tag is the encrypted value of an initial counter value, referred to herein as “Counter 0”, which is the predecessor value (according to a counter increment operation) of the Counter 1 value used for the first block. The initial counter value is encrypted using the same block cipher and key as the counter values for the block encryption operations.

In general, in a second aspect, the invention features a reduced leakage encryption technique for encrypting data using a counter value having an initial length based upon the cipher block size, wherein the counter value is incremented by an incremental value also having a length based upon the cipher block size, wherein the incremental value differs for each block, and the incremental value is a random value. Embodiments of the invention may include one or more of the following features. The initial counter value may be a random value. The initial counter value and the incremental value may each have a length equal to the cipher block size. The length of the initial counter value and the length of the incremental counter value may each be 128 bits.

The reduced leakage encryption techniques disclosed herein may occasionally produce a ciphertext block having the aforementioned exclusive-or property (exclusive-or of ciphertext equals exclusive-or of plaintext), but the frequency of such as occurrence is very low compared to the existing GCM technique, occurring in a single block. For example, in the technique disclosed herein, a single block of encrypted data, e.g., 128 or 256 bits of data, may have the exclusive-or property, but the next block of encrypted data will most likely not have the exclusive-or property.

The ciphertext may be decrypted by reversing the direction of data flow so that the ciphertext is passed to the block encryption cipher, the output of the cipher is passed to the exclusive-or operator, which generates the plaintext by computing the exclusive-or of the output of the cipher and the counter for each block.

### BRIEF DESCRIPTION OF THE DRAWINGS

The present application can be best understood by reference to the following description taken in conjunction with the accompanying drawing figures, in which like parts may be referred to by like numerals:

FIG. 1 illustrates a prior art Galois Counter Mode encryption operation.

FIG. 2A illustrates a data flow diagram of a reduced leakage counter mode encryption operation in accordance with embodiments of the invention.

FIG. 2B illustrates a data flow diagram of a reduced leakage counter mode encryption operation in accordance with embodiments of the invention.

FIG. 2C illustrates a data flow diagram of a reduced leakage counter mode encryption and authentication operation in accordance with embodiments of the invention.

FIG. 2D illustrates a data flow diagram of a reduced leakage counter mode decryption and authentication operation in accordance with embodiments of the invention.

FIG. 3 illustrates a data flow diagram of a reduced leakage counter mode encryption operation with block-sized counters in accordance with embodiments of the invention.

FIG. 4 illustrates a flow diagram of a reduced leakage counter mode encryption and authentication method in accordance with embodiments of the invention.

FIG. 5 illustrates a flow diagram of a reduced leakage counter mode decryption and authentication method in accordance with embodiments of the invention.

FIG. 6 illustrates a typical computing system that may be employed to implement processing functionality in embodiments of the invention.

### DETAILED DESCRIPTION

The following description is presented to enable a person of ordinary skill in the art to make and use the invention, and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention has been described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

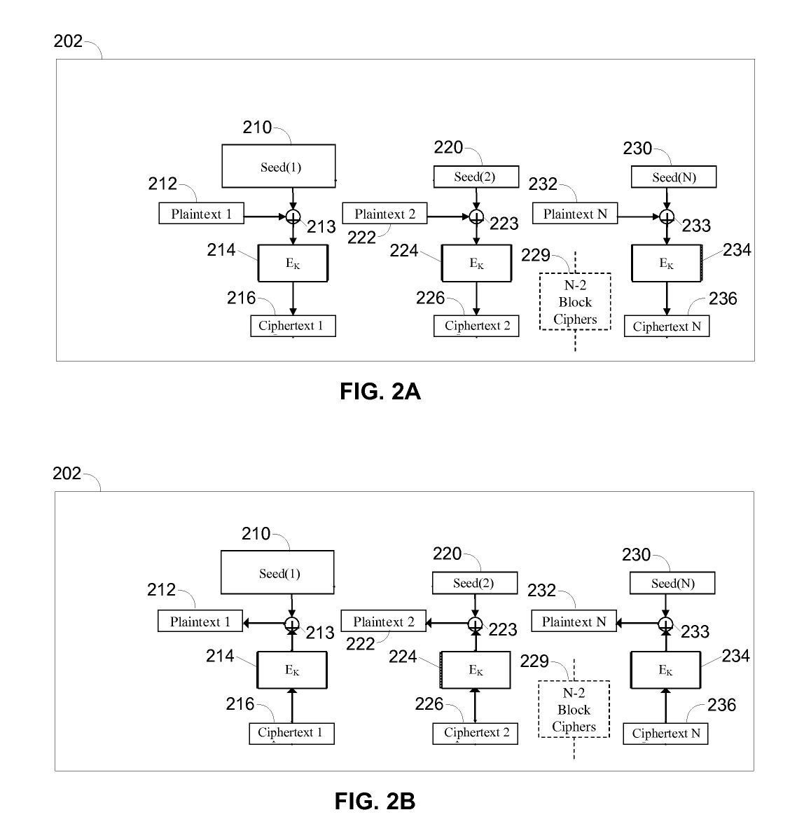

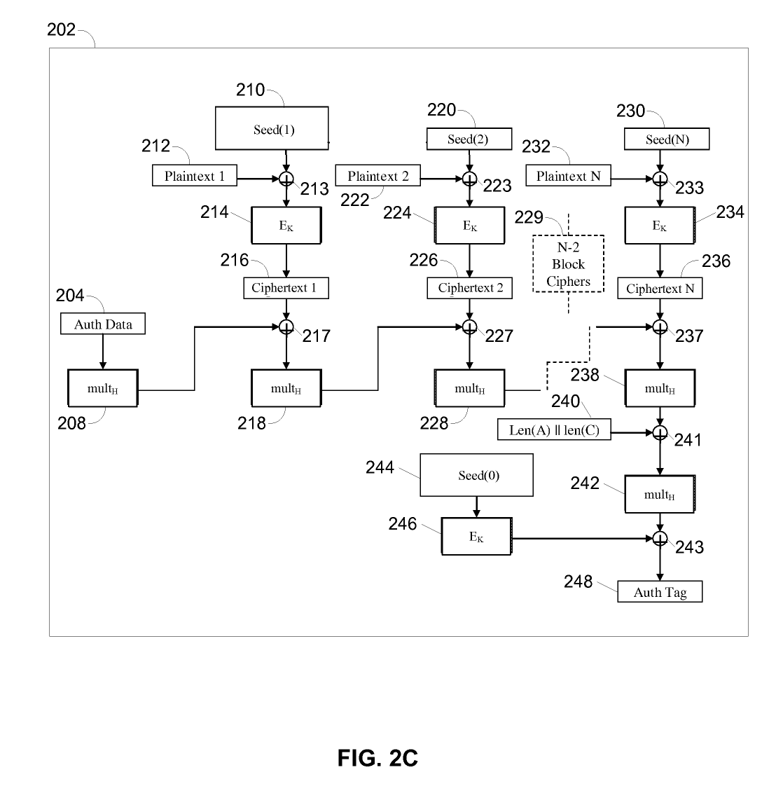

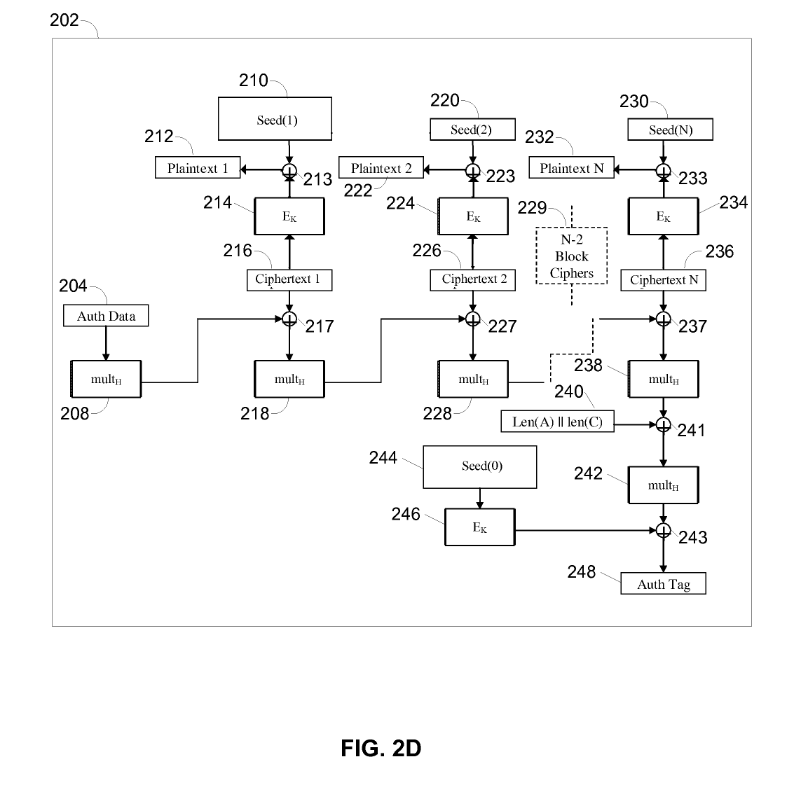

FIG. 2A illustrates a data flow diagram of a reduced leakage counter mode encryption operation in accordance with embodiments of the invention. The data flow diagram represents an encryption operation that executes on a computer system 202 and stores the data values shown, e.g., Plaintext 212, Ciphertext 216, and Seed(1) 210 in the computer system's memory. In one example, the encryption operation may be a computer-implemented method represented by computer program instructions stored in a memory or other storage device of the computer 202, such as a magnetic disk, optical disk, or tape. In another example, the encryption operation may be implemented in hardware, e.g., as an integrated circuit or the like.

The encryption operation of FIG. 2A encrypts a given plaintext block 212 by computing the XOR of a Seed(1) 210 and a plaintext block 212 using an XOR operator 213, and invoking a block encryption operation 214 on result of the XOR operator 213, where the encryption key for the operation 214 is represented by a value K. The encryption operation 214 uses, for example, an AES encryption technique, and produces a ciphertext block 216. The size of the plaintext block 212 is specified by a block size, e.g., 128 bits, 256 bits, or any selected number of bits or bytes. The ciphertext block 216 is the same size as the plaintext block 212. Plaintext data larger than the block size is encrypted by partitioning the plaintext into blocks and applying the block encryption operation to each block, either in parallel, as shown in FIG. 2A, or sequentially. A second plaintext block 222 of the plaintext data is encrypted by the same operations described above for the first block, except that the operations are applied to the second plaintext 222 and a second seed value, Seed(2) 220, to produce a second ciphertext 226. The second block encryption operation 224 uses the same key K and encryption method (e.g., AES) as the first block encryption operation 214, and operates on the XOR of a plaintext block and a seed. The second XOR operator 223 and the second block encryption operation 224 may be referred to as a second block processor. The second block processor is, in one example, the same as a first block processor that includes the first XOR operator 213 and the first block encryption operation 214. An Nth block processor that includes an Nth XOR operator 233 and an Nth block encryption operation 234 is present if needed, i.e., if the size of the plaintext input data is greater than twice the block size. If the size of the plaintext input data is greater than three times the block size, then an additional block processor that includes an XOR operation (not shown) and a block cipher 229 may be used for each additional plaintext data block 232. The block processors may be implemented in computer program code that executes on one or more computer CPU'S, or as one or more hardware devices. Parallel processing can be achieved by executing multiple block encryption operations 214, 224 in parallel on different CPU's or as different hardware devices. For example, there may be a number M of processing units. A 20-block plaintext value would then be encrypted M blocks at a time. If M is 4, then 20 blocks would be encrypted by partitioning the data into 5 chunks and invoking the M processing units 5 times, once for each chunk. The ciphertext blocks 216, 226, 236 would then be assembled into a single encrypted value if necessary.

FIG. 2B illustrates a data flow diagram of a reduced leakage counter mode decryption operation in accordance with embodiments of the invention. The decryption operation is similar to the encryption operation shown in FIG. 2A, except that the decryption operation operates by applying the block encryption operation 214 to the ciphertext 216, and using the XOR operator 213 to generate the XOR of the result of the encryption operation 214 and the seed(1) 210. The result of the XOR operation 213 is the plaintext block 212. The decryption operation can be performed in parallel and/or in serial as described above for the encryption operation.

FIG. 2C illustrates a data flow diagram of a reduced leakage counter mode encryption and authentication operation in accordance with embodiments of the invention. The data flow diagram represents an encryption operation that executes on a computer system 202 and stores the data values shown, e.g., Plaintext 212, Ciphertext 216, Seed(1) 210, and Auth Tag 248, in the computer system's memory. In one example, the encryption operation may be a computer-implemented method represented by computer program instructions stored in a memory or other storage device of the computer 202, such as a magnetic disk, optical disk, or tape. In another example, the encryption operation may be implemented in hardware, e.g., as an integrated circuit or the like.

The operation illustrated in FIG. 2C encrypts one or more blocks of plaintext 212, 222, 232. Three block-encryption operations are shown, labeled 1, 2, and N, with the operations for each block shown in a separate vertical column. Although three blocks are shown in FIG. 2C, any number of operations maybe performed to produce corresponding blocks of ciphertext. The encryption and authentication operation generates ciphertext and an authentication tag 248. Three blocks of cipher text 216, 226, 236 are shown in FIG. 2C.

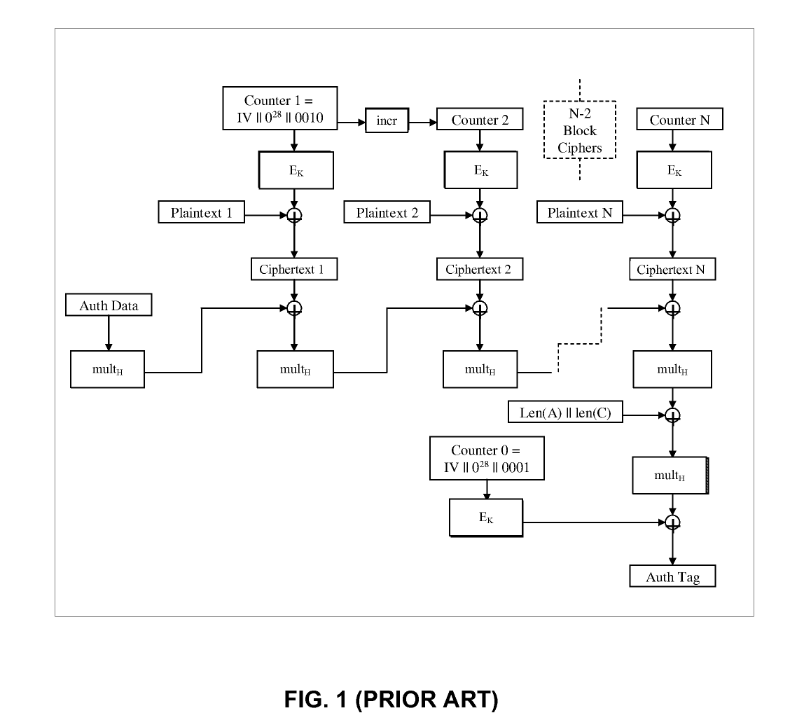

The encryption operation begins by using an XOR operator 213 or other comparison operator to compute the exclusive-or (XOR) of the plaintext 212 and a seed value Seed(1) 210 that corresponds to the first block. The XOR operator 213 may be replaced by other comparison operators or operations, such as an XNOR operator with appropriate modifications to other portions of the encryption operation (e.g., subsequently negating the XNOR operator output). The XNOR operator may also be replaced by, for example, an if-then comparator that generates a value 0 for each bit of the plaintext 212 that is equal to a corresponding bit of the Seed(1) 210, and generates a value 1 for each bit of the plaintext 212 that is not equal to the corresponding bit of the Seed(1) 210. One or more of the exclusive-or operators shown in FIGS. 1 and 2A-2C may be replaced by other comparison operators as described above.

The function Seed(i) represents a seed value used for reducing information leakage. The value of Seed(i) need not be unique for each block i. In one example, the value Seed(i) is generated by a random number generator. In another example, the value Seed(i) is a constant value independent of i. The result of the XOR operation 213 is encrypted by a block cipher 214, e.g., AES or the like, using a secret key K to produce ciphertext 216. The encryption operation performs a second XOR operation 217 on the ciphertext 216 and a previous hash value received from the multiplier 208 of the previous block. In the special case of the first block, there is no previous block, so the initial multiplier 208 multiplies the authentication data 204 by a hash factor H to produce the initial hash value for the XOR operation 217.

The encryption operation continues by encrypting the next block of the data record (if another block is present in the record) using the same technique. That is, for the next block, the encryption operation uses the exclusive-or operator 223 to compute the XOR of the next block of plaintext 222 and Seed(2) to produce the next block of ciphertext 226. The exclusive-or operator 227 computes the XOR of the ciphertext 226 and the multiplication factor computed by the multiplier 218 of the previous block. The XOR operator 223 (and other XOR operators used by the encryption techniques of FIGS. 1 and 2A-2C) may be replaced by other comparison operators or operations, such as an XNOR operator or an if-then operator, as described above with respect to the XOR operator 213.

The encryption operation repeats the steps of XORing Seed(i) with the ith plaintext block to create the ciphertext, the until the last block of plaintext has been encrypted, and generating the authentication tag 248, as described below.

After the last block, shown as block i in FIG. 2C, has been encrypted, and block i's multiplication factor has been computed by the multiplier 238, block i's multiplication factor is XORed with the lengths of the authentication data 204 and the length of the ciphertext. The multiplier 242 then generates a hash value for the result of the XOR operation 241, and the hash value is XORed with the result of the encryption operation 246 to generate the authentication tag 248, i.e., the authentication code for the cipher text.

The operation illustrated in FIG. 2C also generates an authentication tag 248 that can be used to authenticate the ciphertext blocks, i.e., determine whether the ciphertext blocks have been modified subsequent to the encryption operation. The input to the encryption operation includes the plaintext 212, optional initial authentication data 204, and seed values 210, 220, 230.

In reduced leakage encryption technique in accordance with embodiments of the invention, the seed values are generated by a seed function S(i), which maps the block number i to a seed value S(I), where I is an index that corresponds to the position of a block in the plaintext record. The seed values produced by the seed function S(I) need not be unique. If two adjacent one 16-byte block within the plaintext will leak through to the ciphertext.

The reduced leakage encryption technique disclosed herein may occasionally produce a ciphertext block having the aforementioned exclusive-or property (i.e., the XOR of two blocks of ciphertext equals the XOR of two blocks of plaintext), but the frequency of such as occurrence is very low compared to the existing GCM technique, occurring in a single block. For example, in the technique disclosed herein, a single block of encrypted data, e.g., 128 or 256 bits of data, may have the exclusive-or property, but the next block of encrypted data will most likely not have the exclusive-or property.

In existing CTR encryption modes, if any two blocks are encrypted with the same key and counter values, an attacker can compute the exclusive-or of the two blocks of ciphertext, and recover the exclusive-or of the corresponding two blocks of plaintext. However, in the technique described herein, an attacker can know if the two blocks of plaintext data are the same, but cannot discover the differences in plaintext if the plaintext blocks are not the same.

In one example, the reduced leakage encryption method may be defined by equations. The equations use the following variables. The input includes seed values S(0, . . . , N), where N is the number of blocks to be encrypted, i.e., the length of the plaintext divided by the block size. As introduced above, the value S(I) is used as a seed for the I'th block. The length of each seed value S(I) is equal to the cipher block size. In one example, no restrictions are placed on the seed value, i.e., seed values may repeat, or S(I) may equal a constant value for all values of I between 0 and N. The input also includes a secret key K, plaintext P having a length between 0 and 2³⁹-256 bits in one example, and additional authenticated data A to be authenticated but not encrypted, which has a length between 0 and 2⁶⁴ bits in one example. The seed value S has a length equal to the length of the plaintext. The encryption method produces two outputs: ciphertext C, which has a length equal to the length of the plaintext, and an authentication tag T, which has length t.

The reduced leakage encryption operation, which generates the ciphertext C from the plaintext P and the secret key K and the seed values S, may be defined as follows:

$$H = E ( K , {0}^{128} )$$

$${C}_{i} = E ( K , S ( I ) ⊕ {P}_{i} ) , i = 1 , … , n , I = 1 , … , \frac{n}{blocksize}$$

$${C}_{n}^{*} = E ( K , {MSB}_{u} ( S ( N ) ) ⊕ {P}_{n}^{*} )$$

$$T = {MSB}_{t} ( GHASH ( H , A , C ) ⊕ E ( K , S ( 0 ) )$$

The function GHASH is defined in the GCM specification as GHASH(H, A, C)=Xₘ₊ₙ₊₁, where A and C are the additional authenticated data and the plaintext, respectively, and the variables Xᵢ are as defined in the GCM specification.

FIG. 2D illustrates a data flow diagram of a reduced leakage decryption and authentication operation in accordance with embodiments of the invention. The ciphertext may be decrypted by reversing the direction of data flow so that the ciphertext 216 is passed to the block encryption cipher 214, and the output of the cipher 214 is passed to the exclusive-or operator 213 (or other comparison operator), which generates the plaintext 212 by computing the exclusive-or of the output of the cipher and the seed value 210 for each block.

In one example, the decryption operation, which generates the plaintext P from the ciphertext C, the secret key K, and the seed values S previously used for encryption, is described by the following equations:

$$H = E ( K , {0}^{128} )$$

$${T}^{′} = {MSB}_{t} ( GHASH ( H , A , C ) ⊕ E ( K , S ( 0 ) ) \\ {P}_{i} = S ( I ) ⊕ E ( K , {C}_{i} ) , i = 1 , … , n , I = 1 , … , \frac{n}{blocksize} \\ {P}_{n}^{*} = MSB ( S ( N ) ) ⊕ E ( K , {C}_{n}^{*} )$$

The tag T′ generated by the decryption method may be compared to the tag T generated by the encryption method, as described in the GCM specification. If the two tags T and T′ match, then the ciphertext is unmodified and decryption is successful; otherwise, an authentication error is generated.

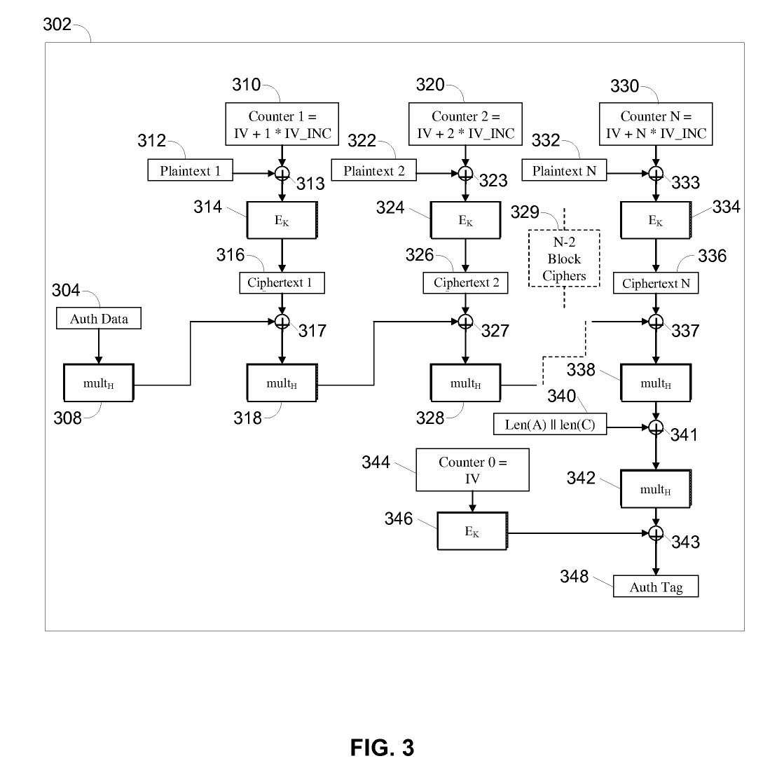

FIG. 3 illustrates a reduced leakage encryption operation with block-sized counters in accordance with embodiments of the invention. The reduced leakage encryption technique executes on a computer system 302 and stores the values shown, e.g., Plaintext, Ciphertext, Counter, and Auth Tag, in the computer system's memory. Furthermore, the technique may be a computer-implemented method represented by computer program instructions stored in a memory or other storage device of the computer 202, such as a magnetic disk, optical disk, or tape.

The reduced leakage encryption operation shown in FIG. 3 encrypts data using a technique similar to that shown in FIG. 2C. In the technique of FIG. 3, the plaintext 312 is XORed with a seed value 310 that is based on the sum of an initialization vector IV and an integer multiple of an increment value IV_INC. IV and IV_INC are distinct, random values chosen before encryption begins. That is, the operation of FIG. 3 corresponds to FIG. 2C with the seed value S(I)=IV+I*IV_INC, where I is the index of the block being processed, e.g., I=0 before any blocks have been processed, I=1 for the first block, and I=N for the Nth block. The lengths of IV and IV_INC are based upon the cipher block length, e.g., 128 bits, 256 bits, or the like. In one example, IV is a 128-bit value that is incremented by IV_INC for each block. That is, the counter value 330 for block number N is IV+N*IV_INC. For example, Counter 0 344 has the value IV, Counter 1 310 has the value IV+1*IV_INC, and Counter 2 320 has the value IV+2*IV_INC. In one example, the encryption operation shown in FIG. 3 is described by the following equations:

$$H = E ( K , {0}^{128} )$$

$${C}_{i} = E ( K , IV + I * IV\_INC ⊕ {P}_{i} ) , i = 1 , … , n , I = 1 , … , \frac{n}{blocksize}$$

$${C}_{n}^{*} = E ( K , {MSB}_{u} ( IV + N * IV\_INC ⊕ {P}_{n}^{*} ) \\ T = {MSB}_{t} ( GHASH ( H , A , C ) ⊕ E ( K , IV )$$

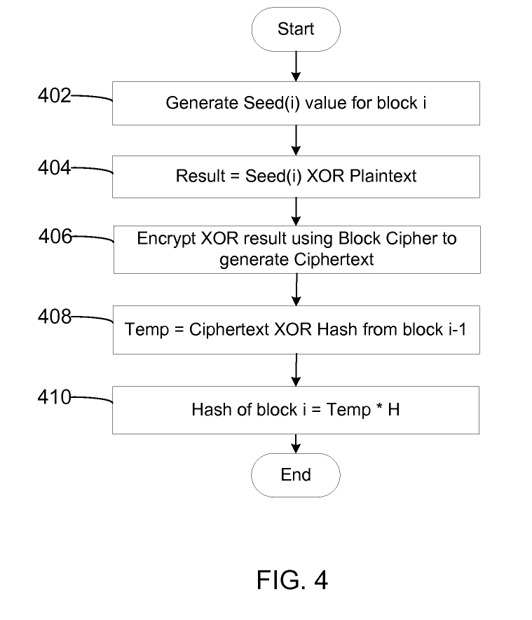

FIG. 4 illustrates a flow diagram of a reduced leakage encryption method in accordance with embodiments of the invention. The method of FIG. 4 may be implemented using computer-executable program instructions stored in a computer-readable medium such as a random access memory or a mass storage device. In one example, the flowchart blocks shown in FIG. 4 perform an encryption operation on a single block of plaintext, e.g., 128 bits of plaintext. The method operates on a block of plaintext that may be selected from a larger plaintext record, and generates a corresponding block of ciphertext and a hash value. The block of ciphertext may be concatenated with ciphertext blocks that correspond to other plaintext blocks. The hash value is based upon a hash value generated by for a previous ciphertext block, or upon an initial value in the case of the first ciphertext block.

Block 402 of the method generates a seed value by, for example, evaluating a function Seed(I) that produces a value based upon the function's argument I, where I is an index of a block of data to be encrypted or decrypted. The function Seed(I) need not produce a unique value for each ciphertext block. The function Seed(I) may also produce a value based upon an initialization vector and the function argument I. The initialization vector may be encrypted and stored as part of the ciphertext. Two seed values Seed(i) and Seed(j) may be the same for different arguments f and j, where f is not equal to j. As an example, Seed(1) produces a first value, such as 44, Seed(2) produces a second value, such as 329, and Seed(3) produces a third value, such as 44. Block 404 computes the exclusive-or of Seed(i) and the I^{th} block of plaintext. Block 406 encrypts the result of block 404 using a block cipher such as AES, thereby producing the I^{th} block of ciphertext. The method is executed for each block, e.g., for blocks 1 to N, where N is the length of the plaintext data record to be encrypted (e.g., some number of bytes usually greater in size than the block size) divided by the block size of the encryption technique (e.g., 128 bits).

Blocks 408 and 410 generate an intermediate value of the authentication code, also referred to herein as a hash value. Blocks 408 and 410 may be omitted if authentication is not desired. Block 408 XOR's the i^{th} block of ciphertext with the hash value produced for the previous ciphertext block (i.e., block i-1). Block 410 multiplies the result of Block 408 by the hash factor H using Galois field multiplication to produce the hash value of ciphertext block i.

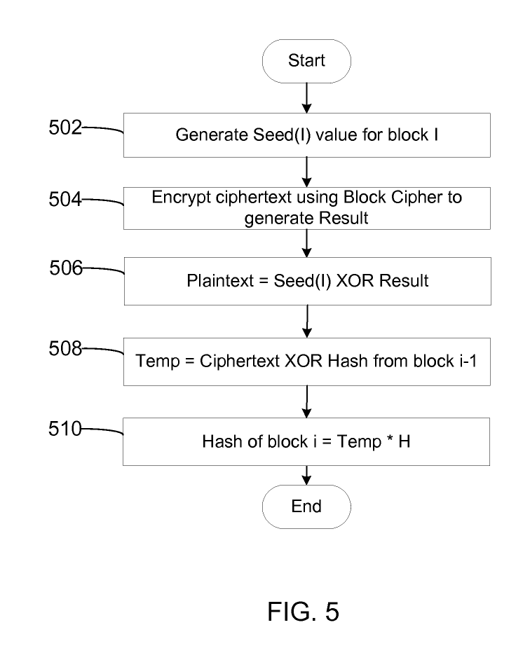

FIG. 5 illustrates a flow diagram of a reduced leakage decryption method in accordance with embodiments of the invention. The method of FIG. 5 decrypts ciphertext such as the ciphertext produced by the encryption method of FIG. 4. Block 502 generates the value Seed(I) for block I, where I is the index of the block being processed by the method, as described above with reference to FIG. 4. In another example, block 502 may retrieve the value of Seed(I) from storage, e.g., from a memory. Block 504 executes the block cipher encryption operation on the ciphertext, thereby generating a result. Block 506 recovers the plaintext by computing the XOR of Seed(I) and the result from block 504.

Other designs, arrangements, and dispositions of various components discussed above are contemplated. For example, cipher block lengths other than 128 bits may be used. A cipher length of 256, 512, 1024 bits, and the like, may be used with appropriate modification of the values n and N.

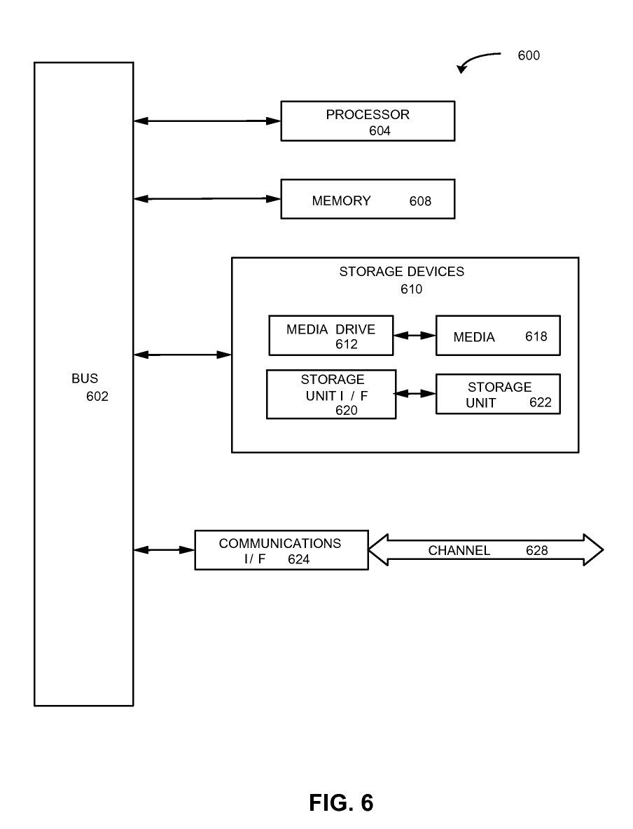

FIG. 6 illustrates a typical computing system 600 that may be employed to implement processing functionality in embodiments of the invention. Computing systems of this type may be used in clients and servers, for example. Those skilled in the relevant art will also recognize how to implement the invention using other computer systems or architectures. Computing system 600 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 600 can include one or more processors, such as a processor 604. Processor 604 can be implemented using a general or special purpose processing engine such as, for example, a microprocessor, microcontroller or other control logic. In this example, processor 604 is connected to a bus 602 or other communication medium.

Computing system 600 can also include a main memory 608, such as random access memory (RAM) or other dynamic memory, for storing information and instructions to be executed by processor 604. Main memory 608 also may be used for storing temporary variables or other intermediate information during execution of instructions to be executed by processor 604. Computing system 600 may likewise include a read only memory (“ROM”) or other static storage device coupled to bus 602 for storing static information and instructions for processor 604.

The computing system 600 may also include information storage system 610, which may include, for example, a media drive 612 and a removable storage interface 620. The media drive 612 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 618, may include, for example, a hard disk, floppy disk, magnetic tape, optical disk, CD or DVD, or other fixed or removable medium that is read by and written to by media drive 614. As these examples illustrate, the storage media 618 may include a computer-readable storage medium having stored therein particular computer software or data.

In alternative embodiments, information storage system 610 may include other similar components for allowing computer programs or other instructions or data to be loaded into computing system 600. Such components may include, for example, a removable storage unit 622 and an interface 620, such as a program cartridge and cartridge interface, a removable memory (for example, a flash memory or other removable memory module) and memory slot, and other removable storage units 622 and interfaces 620 that allow software and data to be transferred from the removable storage unit 618 to computing system 600.

Computing system 600 can also include a communications interface 624. Communications interface 624 can be used to allow software and data to be transferred between computing system 600 and external devices. Examples of communications interface 624 can include a modem, a network interface (such as an Ethernet or other NIC card), a communications port (such as for example, a USB port), a PCMCIA slot and card, etc. Software and data transferred via communications interface 624 are in the form of signals which can be electronic, electromagnetic, optical or other signals capable of being received by communications interface 624. These signals are provided to communications interface 624 via a channel 628. This channel 628 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 608, storage device 618, or storage unit 622. These and other forms of computer-readable media may be involved in storing one or more instructions for use by processor 604, to cause the processor to perform specified operations. Such instructions, generally referred to as “computer program code” (which may be grouped in the form of computer programs or other groupings), when executed, enable the computing system 600 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 600 using, for example, removable storage drive 614, drive 612 or communications interface 624. The control logic (in this example, software instructions or computer program code), when executed by the processor 604, causes the processor 604 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

Although only certain exemplary embodiments have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A computer implemented method of encrypting a block of plaintext, the method comprising:
receiving a seed value;
generating a first value from an operation on the seed value and the plaintext; and
encrypting the first value using a block encryption cipher to produce ciphertext.

2. The method of claim 1, wherein the operation comprises an exclusive-or operation.

3. The method of claim 1, wherein the seed value comprises a counter value based upon a position of the block of plaintext in a record of plaintext, and the length of the counter value is based upon the length of the block.

4. The method of claim 3, further comprising:
generating the counter value by adding an initialization vector to a product of an index value and a multiplier value,
wherein the multiplier value comprises a randomly-generated value,
the index value is based upon the position of the block of plaintext in the record of plaintext, and
the length of the initialization vector and the length of the multiplier value are based upon the length of the block.

5. The method of claim 4, wherein the length of the block, the length of the initialization vector, and the length of the multiplier are each 128 bits.

6. The method of claim 1, further comprising:
generating a hash result based upon a hash factor and a hash of a second ciphertext.
generating a second value from a second operation of the ciphertext and a first hash value received as input; and
generating a second hash value based upon Galois field multiplication of the second value by a hash factor.

7. The method of claim 6, wherein the second operation comprises an exclusive-or operation.

8. The method of claim 1, wherein the block encryption cipher comprises the Advanced Encryption Standard cipher.

9. A computer readable storage medium comprising program code for encrypting a block of plaintext, the program code comprising:
receiving a seed value;
generating a first value from an operation on the seed value and the plaintext; and
encrypting the first value using a block encryption cipher to produce ciphertext.

10. The computer readable medium of claim 9, wherein the operation comprises an exclusive-or operation.

11. The computer readable medium of claim 9, wherein the seed value comprises a counter value based upon a position of the block of plaintext in a record of plaintext, and the length of the counter value is based upon the length of the block.

12. The computer readable medium of claim 11, further comprising program code for:
generating the counter value by adding an initialization vector to a product of an index value and a multiplier value,
wherein the multiplier value comprises a randomly-generated value,
the index value is based upon the position of the block of plaintext in the record of plaintext, and
the length of the initialization vector and the length of the multiplier value are based upon the length of the block.

13. The computer readable medium of claim 12, wherein the length of the block, the length of the initialization vector, and the length of the multiplier are each 128 bits.

14. The computer readable medium of claim 9, further comprising program code for:
generating a hash result based upon a hash factor and a hash of a second ciphertext.
generating a second value from a second operation of the ciphertext and a first hash value received as input; and
generating a second hash value based upon Galois field multiplication of the second value by a hash factor.

15. The computer readable medium of claim 14, wherein the second operation comprises an exclusive-or operation.

16. The computer readable medium of claim 9, wherein the block encryption cipher comprises the Advanced Encryption Standard cipher.

17. A system comprising:
a computer memory for storing instructions; and
a processor for executing the instructions, the instructions for:
receiving a seed value;
generating a first value based from an operation on the seed value and plaintext; and
encrypting the first value using a block encryption cipher to produce ciphertext.

18. The system of claim 17, wherein the operation comprises an exclusive-or operation.

19. The system of claim 17, wherein the seed value comprises a counter value based upon a position of the block of plaintext in a record of plaintext, and the length of the counter value is based upon the length of the block.

20. The system of claim 19, further comprising:
generating the counter value by adding an initialization vector to a product of an index value and a multiplier value,
wherein the multiplier value comprises a randomly-generated value,
the index value is based upon the position of the block of plaintext in the record of plaintext, and
the length of the initialization vector and the length of the multiplier value are based upon the length of the block.

21. The system of claim 20, wherein the length of the block, the length of the initialization vector, and the length of the multiplier are each 128 bits.

22. The system of claim 17, further comprising:
generating a hash result based upon a hash factor and a hash of a second ciphertext generating a second value based upon a comparison of the ciphertext to a first hash value received as input; and
generating a second hash value based upon Galois field multiplication of the second value by a hash factor.

23. The system of claim 22, wherein the comparison comprises an exclusive-or operation.

24. The system of claim 17, wherein the block encryption cipher comprises the Advanced Encryption Standard cipher.
